(19) United States
(12) Patent Application Publication
(10) Pub. No.: US 2019/0394553 A1
(43) Pub. Date: Dec. 26, 2019

(54) Transfer of Battery Charge from Donor to Recipient Appliance

(71) Applicant: Plantronics, Inc., Santa Cruz, CA (US)

(72) Inventors: Victoria Pires, Mountain View, CA (US); Andrew Ward, Capitola, CA (US); Terry M. Carr, Santa Cruz, CA (US)

(73) Assignee: Plantronics, Inc., Santa Cruz, CA (US)

(21) Appl. No.: 16/017,853

(22) Filed: Jun. 25, 2018

(51) Int. Cl. H04R 1/10; H04R 3/00; H04R 5/033

(52) U.S. Cl. CPC H04R 1/1025; H04R 3/00; H04R 2420/07; H04R 1/1016; H04R 5/033

(57) ABSTRACT

Appliances, such as earbuds, configured to be used in pairs or otherwise configured to be operated in communication with one another, are arranged for transferring charge from a donor appliance to a recipient appliance. For the earbud system, a first earbud includes an external contact operatively coupled to the first battery, and the second earbud includes a complementary external contact operatively coupled to the second battery. The external contact on the first earbud and the complementary external contact on the second earbud are arranged for electrical connection to provide power from the first battery on the first earbud for charging the second battery on the second earbud, so that the second earbud can act as a recipient of power from the first earbud which acts as a donor of power.

### BACKGROUND

### Field of the Invention

The present invention relates to technologies for charging a battery on an earbud, including such technologies as applied to wireless or cordless earbuds.

### Description of Related Art

Headsets are used in a variety of settings to provide individual audio appliances for listening to audio streams, interacting with computers, participating in telephone conversations, and so on. A headset can include one or two speaker capsules and, in some embodiments, one or more microphones. Typically, a headset includes a headband to secure the speaker capsules to the user's head at ear level. Headsets can include electronics to support wireless communication with an audio source, such as a smart phone or computer.

Earbuds are a type of audio appliance worn at ear level developed to secure a speaker capsule at ear level without a headband, using on-the-ear mechanisms such as ear tips or ear loops to hold them in place. Wireless communication circuitry can be embedded in the earbuds. When used in pairs, it is common to have a corded or wired connection between the earbuds in the pair.

A class of earbuds is being developed in which pairs of earbuds are not connected by a wire or cord. Rather, earbuds in the pair communicate wirelessly. This can allow the earbuds to be made very small so that they are more easily secured to the ear and more attractive for the wearer.

Wireless earbuds have been developed without physical data ports or charging ports, such as a commonly used micro USB port, to keep them small and to help with water and sweat resistance. Without charging ports, technologies for charging the batteries are being developed that utilize a charging platform configured to make connection to surface contacts on the earbuds. Thus, the wireless earbuds of this type cannot be recharged without having the specialized charging platform in hand. These charging platforms can be left behind or forgotten, causing inconvenience.

It is desirable to provide a technology for charging batteries on earbuds, including wireless earbuds, to make more effective use of battery power.

### SUMMARY

A system is described that includes a first earbud and a second earbud, or other type of appliance, configured to be used in a pair or otherwise configured to be operated in communication with one another.

In an earbud system, the first earbud includes system circuitry, radio circuitry, a speaker and a first battery. The system circuitry includes communication logic to communicate using the radio circuitry with the second earbud, with an audio source, or with both. The second earbud likewise includes system circuitry, radio circuitry, a speaker and a second battery. The system circuitry on the second earbud includes communication logic to communicate using its radio circuitry with the first earbud, with an audio source, or with both. The first earbud includes an external contact operatively coupled to the first battery, and the second earbud includes a complementary external contact operatively coupled to the second battery. The external contact on the first earbud and the complementary external contact on the second earbud are arranged for electrical connection to provide power from the first battery on the first earbud for charging the second battery on the second earbud, so that the second earbud can act as a recipient of power from the first earbud which acts as a donor of power.

In one system configuration described herein, the recipient second earbud is configured for communication using the radio circuitry with an audio source and with the first earbud. In this configuration, the second earbud can act as a master for the audio data communication with the audio source, and the donor first earbud can act as a slave, relying on the connection to the audio source made at the second earbud. As a result, the recipient earbud may utilize more power than the donor earbud during normal operation, for example by maintaining the radio communication with the audio source. In some settings, the recipient earbud may include multiple radios to support communication channels with an audio source and with the donor earbud, while the donor earbud may include one radio, or a smaller number of radios, which consume power during normal operation. In some settings, the recipient earbud may utilize a smaller battery than the donor earbud.

An example is described in which the first earbud includes a plurality of external contacts and the second earbud includes a plurality of complementary external contacts, utilized in support of charging a battery on the second earbud. The plurality of contacts on the first earbud can include a contact as mentioned above for providing power from the first battery to the second battery, and in addition a power input contact for receiving charging power for the first battery, a ground contact and a sense contact. The plurality of complementary contacts on the second earbud, in addition to the first mentioned external contact above, for receiving power from the first battery for use in charging the second battery, can include a ground contact, and a complementary sense contact. The second earbud can include an electronic component connected between the sense contact and the ground contact which generates a response signal in response to stimulus on the sense contact. The first earbud can include a circuit connected between the ground contact and the sense contact on the first earbud, to provide the stimulus and detect the response. Circuitry on the first earbud can respond to detection of the response by enabling the supply of power via the power output contact to the second earbud. In some embodiments, the first earbud can include a stimulus input contact and the second earbud can include a stimulus output contact which is coupled to the electronic component. The circuitry on the first earbud can be connected to the stimulus input contact to detect the response.

In other embodiments, the first and second earbuds can include circuitry to execute a handshake protocol to detect electrical contact between the external contact on the first earbud and the complementary external contact on the second earbud.

A variety of techniques can be used to support coupling of the first and second earbuds for the purposes of transferring charge as described herein. In one example, a first magnetic element is disposed on the first earbud and a second magnetic element is disposed on the second earbud in order to magnetically attract the first and second earbuds for electrical contact between the external contact and the complementary external contact on the earbuds. In another example, a mechanical interlock can be utilized having a first element on the first earbud and a complementary second element on the second earbud. Mechanical interlock can be configured to position the first and second earbuds for electrical contact. In yet another example, a twist lock coupler can be utilized having a first element on the first earbud, such as a cylindrical threaded protrusion, and a second element on the second earbud, such as a cylindrical threaded recess. The twist lock coupler can also be formed using a tab and slot configuration instead of or in combination with threaded surfaces.

As mentioned above, the technology described herein is extendable to use on appliances other than earbuds, including appliances having communication circuitry supporting their use in pairs.

Other aspects and advantages of the present invention can be seen on review of the drawings, the detailed description and the claims, which follow.

### BRIEF DESCRIPTION OF THE DRAWINGS

FIG. 1 is simplified illustration of a pair of wireless earbuds configured for transferring charge from a donor earbud to a recipient earbud.

FIGS. 2A and 2B illustrate a twist lock configuration for coupling the first and second earbuds.

FIG. 3 is a schematic system diagram for first and second earbuds according to an embodiment of the technology described herein.

FIG. 4 is a schematic system diagram for first and second earbuds according to another embodiment of the technology described herein.

FIGS. 5A and 5B illustrate first and second earbuds configured for magnetic coupling.

FIGS. 6A and 6B illustrate first and second earbuds having a mechanical interlock.

### DETAILED DESCRIPTION

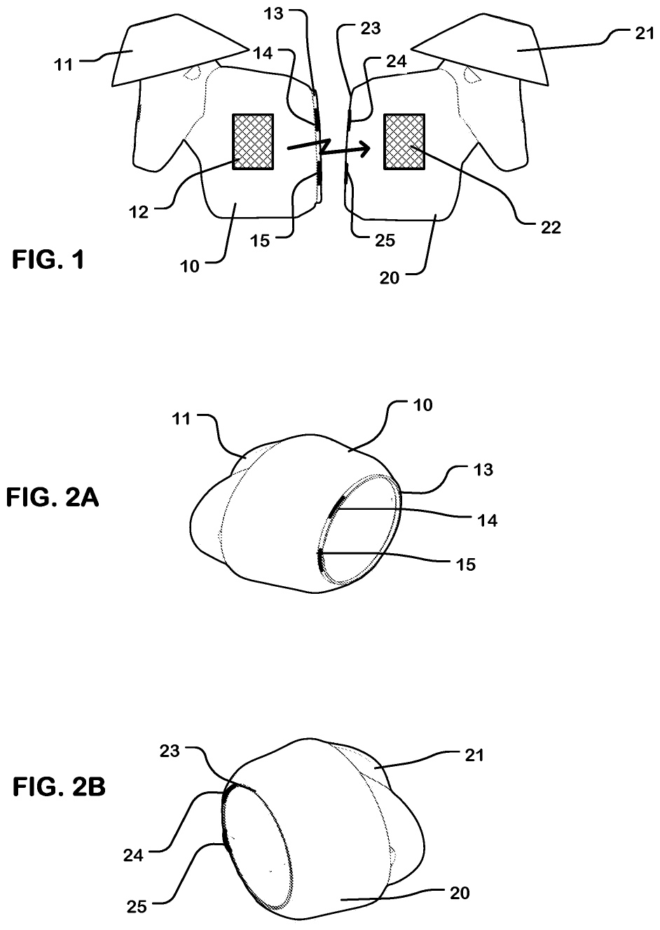

A detailed description of embodiments of the present invention is provided with reference to the FIGS. 1-6B.

FIG. 1 illustrates a pair of wireless earbuds configured to allow transfer of charge from a donor earbud to a recipient earbud for the purposes of battery charging. The first earbud includes a capsule 10 and an ear tip 11. The capsule 10 contains electronic circuitry 12 including a first battery supporting operation of the earbud. The capsule 10 includes or is connected to an element containing a speaker to be positioned in the ear canal of the user. The ear tip 11 in this example is a flexible member adapted to secure the earbud to the ear. Likewise, the second earbud includes a capsule 20 and an ear tip 21. The capsule 20 contains electronic circuitry 22 including a second battery supporting operation of the earbud. The capsule 20 includes or is connected to an element containing a speaker to be positioned in the ear canal of the user. The ear tip 21 in this example is a flexible member adapted to secure the earbud to the ear. In some embodiments, one or more microphones may be included on the earbuds.

The capsule and ear tip of the earbud can have a variety of configurations, that support different modalities for supporting the earbuds at ear level and containing the electronics, the speaker, the battery and other components.

In the illustration, the first earbud including the circuitry 12 in capsule 10 is configured to supply power to the second earbud including circuitry 22 in capsule 20, for the purposes of charging a battery in the second earbud. The earbuds are configured to be positioned to place the cylindrical protrusion 13 and cylindrical recess 23, in this example, in proximity, or in direct contact, which can be twisted to lock the components together. In the coupled position, electrical connection is established between external contacts 14 and 15 on the capsule 10 and complementary external contacts 24 and 25 on the capsule 20. One or both of the external contacts 14 and 15 on the capsule 10 is operatively coupled to a battery in the capsule 10, and one or both of the complementary external contacts 24 and 25 is operatively coupled to a battery in the second capsule 20 to allow transfer of power via the external contacts for charging the second battery using the first battery.

FIG. 2A is a perspective view of a capsule 10 and ear tip 11 that includes a cylindrical protrusion 13 having contacts 14 and 15 formed thereon, that provides a first element of a twist lock coupler for coupling the first and second earbuds together. In FIG. 2B, a perspective view of the capsule 20 and ear tip 21 is shown in which a cylindrical recess 23 is provided with complementary threading for coupling with the cylindrical protrusion 13. Contacts 24 and 25 can be formed on the cylindrical surfaces of the cylindrical recess 23. In other embodiments, the contacts can be formed on the facing surfaces of the components inside the cylindrical elements of the twist lock coupler. In some embodiments, there are more than two external contacts on each earbud capsule used to support the transfer of charge as described herein.

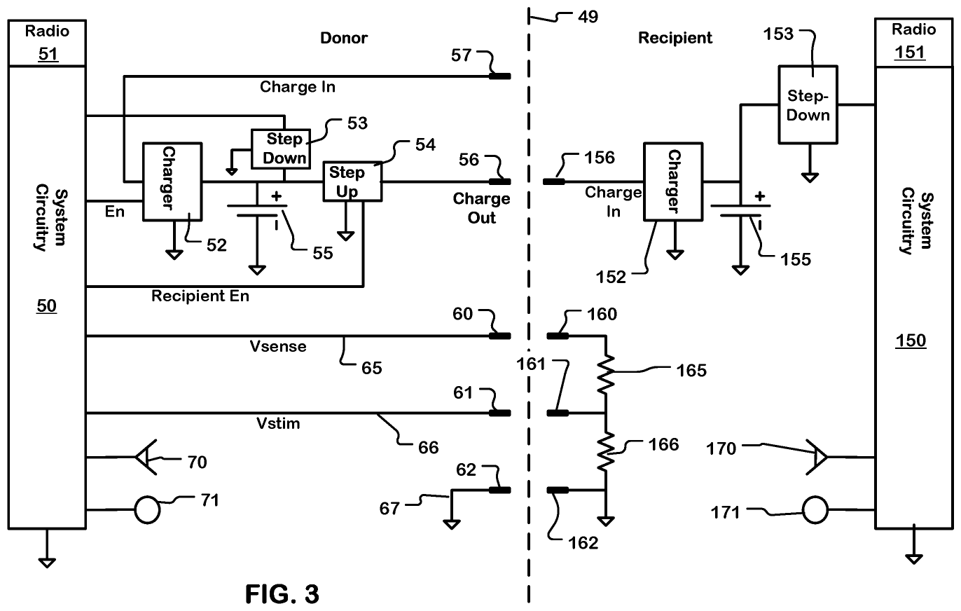

FIG. 3 is a schematic diagram of electronic circuitry on a first earbud configured as a donor of electric power for battery charging of a battery on a second earbud, and a second earbud configured as a recipient of the electric power for charging its battery. An electrical interface between the donor and recipient earbuds is established schematically at the interface 49, when the earbuds are placed in contact.

The donor earbud includes system circuitry 50 and radio circuitry 51. Also, the donor earbud includes a speaker 70, and a microphone 71. The system circuitry 50 includes analog and digital circuitry utilized in receiving and processing audio data, and audio driver and receiver circuitry for driving the speaker 70 and the microphone 71. The radio circuitry 51 can include one or more than one radio, including for example a radio (e.g., RF electromagnetic radio) configured for radio communication with an audio source such as a smart phone, a computer or other type of audio source appliance, and a radio (e.g., near field magnetic induction radio) configured for shorter range communication with another earbud with which it is paired. The system circuitry 50 can include communication logic supporting a protocol such as a Bluetooth compliant protocol, used for communication with an audio source, and a protocol, such as a Near Field Magnetic Induction NFMI compliant protocol, used for communication with its paired earbud. Of course, one radio with one or more than one protocol can be used for communication with both the audio source and the paired earbud in some implementations.

The system circuitry 50 can include a general purpose processor or digital signal processor, along with memory storing computer programs and parameters utilized in operation of the earbud, and along with the communications logic. In addition, the system circuitry 50 can include analog circuitry operated in support of operation of the earbud.

As illustrated in FIG. 3, on the donor side, a charger 52 is coupled to the system circuitry 50. The charger 52 is coupled to a battery 55, and to a charge input contact 57. The charge input contact 57 is configured for connection to an external power source, such as a charging platform designed to mate with the earbud. When power is applied on the contact 57, and the charger 52 is enabled in response to a signal (En) from the system circuitry 50, the charger 52 supplies charge to the battery 55. DC/DC step-down circuitry 53 is coupled to the battery 55 which translates the battery output power which can be for example 4.2 to 4.35 V for a typical lithium battery, into a VDD power for the system circuitry, which can be for example 1.8 to 3.3 V.

As illustrated in FIG. 3, DC/DC step-up circuitry 54 is coupled to the battery 55, and configured to apply power from the battery 55 to an external charge-out contact 56, that is arranged for applying power to the recipient earbud. The step-up circuitry 54 is configured for the battery or battery charging circuits on the recipient earbud, and may be replaced by other types of circuitry for transferring power in some embodiments.

Step-up circuitry 54, in this embodiment, is enabled by a recipient enabled signal (Recipient En) from the system circuitry to apply charging power to the recipient earbud. When not enabled, the step-up circuitry 54 can be set in a mode that consumes little or no background power in order to conserve battery power on the donor earbud.

The donor earbud also includes circuitry to detect electrical contact between external charge-out contact 56 on the donor earbud, and a complementary external contact 156 on the recipient earbud, and in response to the detection of the electrical contact, to enable charging of the second battery. Thus, the system circuitry 50 can assert the recipient enable signal (Recipient En) to turn on the step-up circuitry 54, by which the battery 55 is operatively coupled to the external charge-out contact 56.

The circuitry to detect electrical contact in the embodiment of FIG. 3 includes a ground contact 62 coupled by line 67 to the earbud ground, a sense contact 60 coupled to the system circuitry 50 by line 65, and a stimulus input contact 61, which is coupled by line 66 to the system circuitry 50. The system circuitry includes logic to apply Vsense to the sense contact 60, and to detect a voltage Vread on the stimulus input contact 61. The recipient earbud includes an electronic component which responds to the voltage Vsense by applying a stimulus output signal on its external stimulus output contact 161, which is disposed in a complementary manner to the stimulus input contact 61 on the donor earbud. In an example embodiment, circuitry in the system circuitry to apply Vsense and to detect Vread can include a voltage regulator which is coupled to the power supply signal V_{DD} to apply the voltage Vsense and a reference voltage. The system circuitry can include a comparator which compares the reference voltage generated by the system circuitry 50 with the voltage Vread. Alternatively, the system circuitry 50 can include a switch which is turned on by a voltage Vread of sufficient magnitude to indicate coupling of the donor and recipient earbuds.

The system circuitry 50 can include a general purpose processor or digital signal processor, along with memory storing computer programs and parameters utilized in operation of the earbud, along with communications logic. In addition, the system circuitry 50 can include analog circuitry operated in support of operation of the earbud.

The recipient earbud likewise can include system circuitry 150 and radio circuitry 151 which can be like that of the donor earbud in some embodiments. The recipient earbud may include the same type of circuitry as the donor earbud, or modified circuitry depending on the functional roles being executed by the donor and recipient earbuds. In embodiments of the technology described herein, the recipient earbud may execute functions that consume greater power than the donor earbud, may include more power consuming circuitry than the donor earbud, or may have a smaller battery than the donor earbud.

Also the recipient earbud can include a speaker 170 and in some embodiments a microphone 171. The recipient earbud includes external contacts that are complementary with a plurality of external contacts on the donor earbud. Thus, the recipient earbud includes a charge-in contact 156 which is complementary with the external charge-out contact 56 on the donor earbud. Also, the recipient earbud in this example includes a Vsense input contact 160 which is complementary with the sense contact 60 at which Vsense is output on the donor earbud. The recipient earbud in this example includes a stimulus output contact 161 complementary with the stimulus input contact 61 on the donor earbud. Also, the recipient earbud includes a ground input contact 162 which is complementary with the ground output contact 62 on the donor earbud.

A resistor ladder including resistor 165 and resistor 166 is connected in series between the Vsense input contact 160 and the ground input contact 162, with the stimulus output contact 161 coupled to a node in the resistor ladder between the resistors 165 and 166. The resistors 165, 166 can have relatively high resistance levels, to minimize power consumption during the coupling and sensing operations. Other types of passive electronic components, such as capacitors or inductors and the like, can be utilized for the purposes of generating a stimulus output in response to an input from a donor earbud. In other embodiments, the electronic component can be an active component, such as a transistor or diode, or a combination of active and passive elements.

On the recipient earbud, the charge-in contact 156 is operatively coupled to the battery 155, to receive power from the battery 55 on the donor earbud. In this example, the second earbud includes a charger 152 which is coupled to the charge-in contact 156. The charger 152 is coupled to the battery 155, and applies power received on the contact 156 to charge the battery 155.

Also the battery 155 is connected via step-down circuitry 153 to the system circuitry 150.

The recipient earbud may include an additional external contact (not shown) to receive power from a charging platform, like contact 57 on the donor earbud. Alternatively, the charge-in contact 156 can be configured for use in connection to the donor earbud as well as connection to a charging platform.

The battery 55 and the battery 155 in a representative earbud system may comprise a rechargeable lithium battery with a capacity of 30 to 75 milliAmp-hour (mAh), typically less than 150 mAh. Of course other battery types and sizes can be utilized.

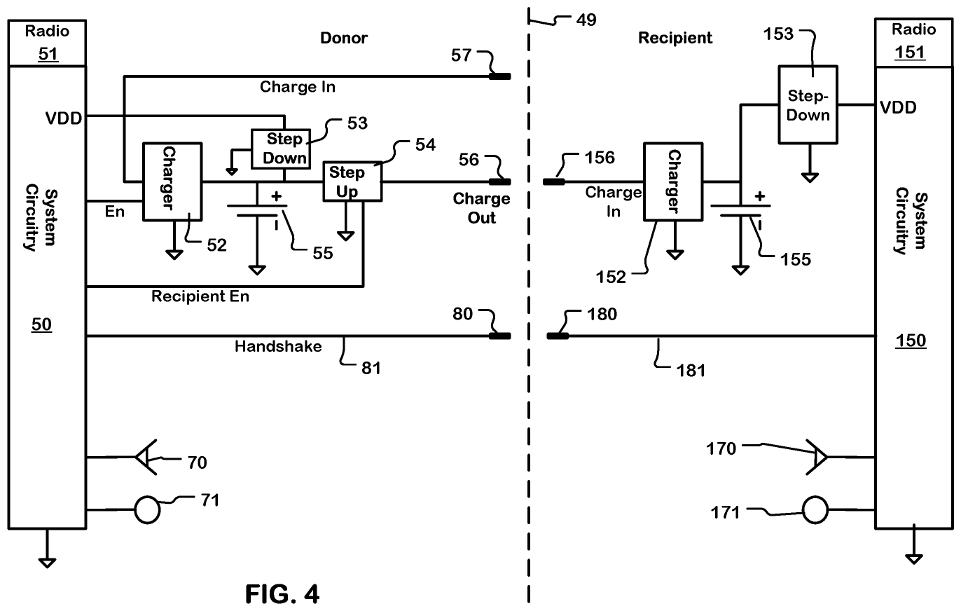

FIG. 4 illustrates an alternative embodiment illustrating the possibility of using different types of circuitry to detect electrical contact, in which components described with reference to FIG. 3 receive the same reference numerals and are not described again. In the embodiment of FIG. 4, the circuitry to sense electrical contact between the external charge-out contact 56 and the charge-in contact 156 comprises a handshake connection formed by contact 80 on the donor earbud and contact 180 on the recipient earbud. A contact 80 on the donor earbud is coupled to the system circuitry 50 by line 81, and the contact 180 on the recipient earbud is coupled to the system circuitry 150 by line 181. The donor earbud system circuitry 50 and the recipient earbud system circuitry 150 can execute a handshake protocol, assuming sufficient battery power is available in the recipient earbud, to detect coupling of the contacts on the devices across the interface 49, which indicates electrical contact between the external charge-out contact 56 and the external contact 156.

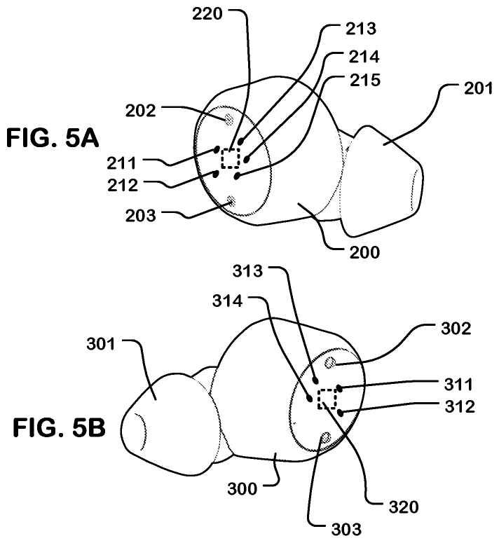

FIGS. 5A and 5B illustrate a donor earbud and a recipient earbud respectively configured with external contacts to support circuitry like that of FIG. 3. Also, a means for coupling the donor earbud and recipient earbud in this example includes a first magnetic element on the donor earbud shown in FIG. 5A and a second magnetic element on the recipient earbud shown in FIG. 5B, which are configured to magnetically attract the contact surfaces of the ear buds to make electrical connection on the external contacts on the donor and complementary external contacts on the recipient.

The donor earbud in FIG. 5A includes a capsule 200 and ear tip 201. A plurality of external contacts 211-215 (five as in the example of FIG. 3) is arranged on a coupling surface of the capsule 200. Alignment bumps 202, 203 are positioned on the coupling surface to facilitate alignment of the external contacts 211-215 with complementary external contacts on the recipient earbud. A magnetic element 220 is disposed on the surface or beneath the surface for the purpose of forming the attractive magnetic field between the donor and recipient earbuds.

The recipient earbud shown in FIG. 5B includes capsule 300 and ear tip 301, with recesses 302 and 303 formed on a coupling surface of the capsule 300, which are configured to receive the alignment bumps 202, 203 on the donor earbud. A magnetic element 320 is disposed on the surface or beneath the surface for the purpose of forming the attractive magnetic field between the donor and recipient earbuds. Also, the recipient earbud includes a plurality of complementary external contacts 311-314 (four as in the example of FIG. 3) arranged on the coupling surface in a manner complementary to the external contacts 211-214 on the donor earbud shown in FIG. 5A.

In the embodiment of FIGS. 5A and 5B, the external contacts on the donor earbud and the complementary external contacts on the recipient earbud are arrayed on a contact surface around a magnetic element which is disposed centrally. In other embodiments, these contacts can be positioned on adjacent surfaces or other surfaces of the earbud capsule that are brought into proximity or contact by the magnetic coupling structure. Likewise, the magnetic elements can be arrayed in different configurations as suits a particular implementation.

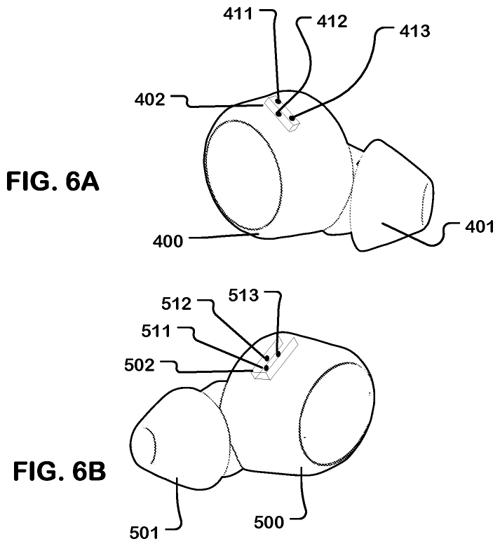

FIGS. 6A and 6B illustrate a donor earbud and a recipient earbud, respectively, configured with a mechanical interlock having a first element 402 on the donor earbud and a second element 502 on the recipient earbud. The donor earbud shown in FIG. 6A includes a capsule 400 and an ear tip 401. The first element 402 of the mechanical interlock is positioned on a side surface of the capsule 400. External contacts 411-413 are arrayed along the first element 402 of the mechanical interlock.

The recipient earbud shown in FIG. 6B includes capsule 500 and ear tip 501. The second element 502 of the mechanical interlock is positioned on a side surface of the capsule 500. External contacts 511-513 are arrayed on the second element 502 of the mechanical interlock in a manner complementary to the external contacts 411-413 formed on the donor earbud.

In the embodiment of FIGS. 6A and 6B, the external contacts on the donor earbud and the complementary external contacts on the recipient earbud are arrayed on the mechanical interlock structure. In other embodiments, these contacts can be positioned on adjacent surfaces or other surfaces of the earbud capsule that are brought into proximity or contact by the mechanical interlock structure.

The mechanical interlock, the magnetic coupler, and the twist lock coupler described above are examples of means for positioning the donor and recipient earbuds in proximity for the purposes of establishing electrical contact between the external contacts on the donor earbud and the complementary external contacts on the recipient earbud.

Although examples are described herein which involve donor and recipient earbuds which are wirelessly coupled for purposes of the earbuds mission functions, the charging techniques can be applied to earbuds with other configurations of communication technologies.

Also, the embodiments described above relate to paired earbuds. The donor/recipient charging technologies described herein can also be applied in other types of wireless, battery-operated appliances that are used in pairs.

Thus, technology is provided in order to make more efficient use of battery power on wireless earbuds and other types of appliances. The technology takes advantage of the asymmetric power consumption of paired devices, enabling one of the pairs which may consume less power to share excess power with its paired device. In this way, the time between charging at a specific charging station can be increased.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims. What is claimed is:

1. A shared charging system, comprising:
a first appliance and a second appliance configured to be operated in communication with one another;
the first appliance including communication circuitry for communication with the second appliance, a first battery, and an external contact operatively coupled to the first battery;
the second appliance including communication circuitry for communication with the first appliance, a second battery and a complementary external contact operatively coupled to the second battery; and
the external contact on the first appliance and complementary external contact on the second appliance are configured to be in direct contact to one another to provide power from the first battery on the first appliance for charging the second battery on the second appliance,
wherein the first appliance comprises a plurality of external contacts, including the first mentioned external contact, a power output contact, a ground contact, and a sense contact, and including a circuit connected between the ground contact and the sense contact to provide stimulus and to detect a stimulus response, and in response to detection of the response, to enable supply of power via the power output contact, and
wherein the second appliance comprises a plurality of complementary external contacts, including the first mentioned complementary external contact, a ground contact, and a sense contact, and including an electronic component connected between the ground contact and the sense contact which generates the stimulus response in response to stimulus on the sense contact.

2. The system of claim 1, wherein the first appliance includes circuitry to detect electrical contact between the external contact on the first appliance and the complementary external contact on the second appliance, and in response to enable charging of the second battery.

3. The system of claim 1, including a first magnetic element on the first appliance and a second magnetic element on the second appliance disposed to magnetically attract the first and second appliances for electrical contact between the external contact and complementary external contact.

4. The system of claim 1, including a mechanical interlock having a first element on the first appliance and a complementary second element on the second appliance configured to position the first and second appliances for electrical contact between the external contact and complementary external contact.

5. The system of claim 1, including a twist lock coupler having a first element on the first appliance and a complementary second element on the second appliance configured to position the first and second appliances for electrical contact between the external contact and complementary external contact.

6. (canceled)

7. The system of claim 1, wherein the first appliance includes a stimulus input contact, and the second appliance includes a stimulus output contact.

8. The system of claim 1, wherein the first appliance and second appliance include circuitry to execute a handshake protocol to detect electrical contact between the external contact on the first appliance and the complementary external contact on the second appliance, and in response to the handshake protocol, to enable charging of the second battery.

9. A shared charging system, comprising:
a first earbud and a second earbud,
the first earbud including system circuitry, radio circuitry, a speaker, a first battery, the system circuitry including communication logic to communicate using the radio circuitry with the second earbud, wherein the first earbud includes an external contact operatively coupled to the first battery;
the second earbud including system circuitry, radio circuitry, a speaker, and a second battery, the system circuitry including communication logic to communicate using the radio circuitry with the first earbud, wherein the second earbud includes a complementary external contact operatively coupled to the second battery; and
the external contact on the first earbud and complementary external contact on the second earbud are configured to be in direct contact to one another to provide power from the first battery on the first earbud for charging the second battery on the second earbud,
wherein the first earbud comprises a plurality of external contacts, including the first mentioned external contact, a power output contact, a ground contact, and a sense contact, and including a circuit connected between the ground contact and the sense contact to provide stimulus and to detect a stimulus response, and in response to detection of the response, to enable supply of power via the power output contact, and
wherein the second earbud comprises a plurality of complementary external contacts, including the first mentioned complementary external contact, a ground contact, and a sense contact, and including an electronic component connected between the ground contact and the sense contact which generates the stimulus response in response to stimulus on the sense contact.

10. The system of claim 9, wherein the first earbud includes circuitry to detect electrical contact between the external contact on the first earbud and the complementary external contact on the second earbud and, in response, to enable charging of the second battery.

11. The system of claim 9, including a first magnetic element on the first earbud and a second magnetic element on the second earbud disposed to magnetically attract the first and second earbuds for electrical contact between the external contact and complementary external contact.

12. The system of claim 9, including a mechanical interlock having a first element on the first earbud and a complementary second element on the second earbud configured to position the first and second earbuds for electrical contact between the external contact and complementary external contact.

13. The system of claim 9, including a twist lock coupler having a first element on the first earbud and a complementary second element on the second earbud configured to position the first and second earbuds for electrical contact between the external contact and complementary external contact.

14. (canceled)

15. The system of claim 9, wherein the first earbud includes a stimulus input contact, and the second earbud includes a stimulus output contact.

16. The system of claim 9, wherein the first earbud and second earbud include circuitry to execute a handshake protocol to detect electrical contact between the external contact on the first earbud and the complementary external contact on the second earbud, and in response to the handshake protocol, to enable charging of the second battery.

17. The system of claim 1,
wherein the first appliance includes a protrusion including the external contact,
wherein the second appliance includes a recess including the complementary external contact, and
wherein the protrusion and the recess are configured to directly couple the first appliance and the second appliance together to provide the direct contact between the external contact and the complementary external contact.

18. The system of claim 17, wherein the protrusion is cylindrical and the recess is cylindrical.

19. The system of claim 9,
wherein the first earbud includes a protrusion including the external contact,
wherein the second earbud includes a recess including the complementary external contact, and
wherein the protrusion and the recess are configured to directly couple the first earbud and the second earbud together to provide the direct contact between the external contact and the complementary external contact.

20. The system of claim 19, wherein the protrusion is cylindrical and the recess is cylindrical
